(19) United States
(12) Patent Application Publication
(10) Pub. No.: US 2021/0028459 A1
(43) Pub. Date: Jan. 28, 2021

(54) POSITIVE POLE MATERIAL, POSITIVE POLE, BATTERY AND BATTERY PACK

(71) Applicant: AAB Technology (HK) Limited, Kowloon (HK)

(72) Inventor: Zhonglai Pan, Hong Kong (CN)

(21) Appl. No.: 16/938,830

(22) Filed: Jul. 24, 2020

Related U.S. Application Data
(60) Provisional application No. 62/879,171, filed on Jul. 26, 2019.

(30) Foreign Application Priority Data
Jul. 3, 2020 (CN) 202010631034.6

(51) Int. Cl. H01M 4/60; H01M 4/64; H01M 4/24

(52) U.S. Cl. CPC H01M 4/604; H01M 4/244; H01M 4/64

(57) ABSTRACT

A positive pole material, positive pole, battery and battery pack are provided. The positive pole material comprises a positive pole protector which is a compound containing both a hydrophobic chain and a chelation group. The positive pole comprises a positive pole current collector and the positive pole material. The battery comprises an electrolyte, a negative pole, and the positive pole. The battery pack comprises the batteries in series or in parallel.

### CROSS REFERENCE TO RELATED APPLICATIONS

This application claims priority to U.S. Provisional Patent Application No. 62/879,171 filed on Jul. 26, 2019, and China Patent Application No. 202010631034.6 filed on Jul. 3, 2020; each of which is hereby incorporated by reference in its entirety.

### FIELD OF THE INVENTION

The present invention relates to a positive pole material, a positive pole, a battery and a battery pack, relating to the field of electrochemical batteries.

### BACKGROUND OF THE INVENTION

With the escalating demands towards smaller portable devices and electric vehicles, suitable sustainable power supply sources are being sought that are efficient, compact, lightweight and safe. Generally, rechargeable batteries are used as sustainable power supply.

Lithium ion batteries offer great advantages as a rechargeable battery due to their high electron density and low self discharge rate. Nevertheless, its disadvantages are gradually exposed with the expansion of application and research. Lithium batteries are made of flammable organic electrolytes, which significantly reduces its safety. Furthermore, the electrodes of lithium batteries are prepared in an anhydrous environment, leading to higher production battery costs. Scientists have been looking for alternative rechargeable battery systems that have the potential to replace these lithium batteries. Aqueous batteries that are safer, cheaper and environmentally friendly would undoubtedly be perfect alternatives.

With multiple oxidation states (+2, +3, +4), manganese-based positive pole materials have been commonly used in rechargeable batteries (including aqueous rechargeable zinc batteries). Manganese has the ability to utilize a high number of redox couples, providing batteries that feature high thermal stability, reasonable price, environmentally safe, high capacity and long service life. However, there are complications associated with these types of batteries.

Battery cell performance of these manganese-based aqueous rechargeable zinc batteries are often limited during the repeated charging and discharging process by decrease in capacity which can lead to shorter battery cycle life. Poor cycling performance can be attributed to the formation of inactive side products on positive pole, or cathode surface originated from manganese ion dissolution. The inherent Jahn-Teller distortion effect of these manganese-based positive poles can also lead to the accumulation of lithium ions, thus expediting dissolution of manganese ions, resulting in battery capacity decay. Additionally, the common side reaction in these types of batteries, namely the decomposition water H₂O (2H₂O→O₂+4H⁺+4e⁻), can lead to the oxidation of conductive materials (like carbon), influence its conductivity performance and further reducing cycle life of the batteries.

Currently, in order to prevent degeneration of the positive pole and extend the battery service life, protective coating additives are generally mixed or applied in the positive pole in the prior art to increase the structural stability of electrode during electrochemical cycle process.

For the foregoing reasons, there exists a need for additives to protect positive poles or cathodes in aqueous rechargeable zinc batteries which offer significant protection against battery capacity fading while enhancing cycling stability during the charging and discharging process. Further, it would be advantageous to have these protective additives to be able to maintain its performance for prolonged periods of time, and be efficient, safe, effective and low cost.

### SUMMARY

The present invention is directed to positive pole materials as additives for cycle life extension in aqueous rechargeable batteries. Positive poles, batteries, and battery packs which include these positive pole materials are also disclosed.

In accordance to the present disclosure, a positive pole material for rechargeable batteries is provided.

A positive pole material may include a positive pole protector. The positive pole protector preferably is a compound containing a hydrophobic chain and a chelation group. Typically, the hydrophobic chain comprises at least one of an alkyl chain, a siloxy chain and a fluoroalkyl chain; and the chelation group comprises at least one of a cyano group, an amino group, a secondary amino group, a tertiary amino group, a carboxyl group, an oxhydryl group, a sulfonyl group and an acylamino group.

In one embodiment, the hydrophobic chain comprises a number of backbone atoms from about 2 to about 12.

In another embodiment, the hydrophobic chain comprises at least one of an alkyl chain and a fluoroalkyl chain, and the chelation group comprises at least one of a cyano group, an amino group, a secondary amino group, a tertiary amino group, a carboxyl group, an oxhydryl group, a sulfonyl group and an acylamino group. In one embodiment, the hydrophobic chain is a straight chain.

According to a preferable embodiment of the present disclosure, the general formula of the positive pole protector comprises Formula I or II;

Formula I is CHₐF_{b}A_{3-a-b}-CₘFₙH₂ₘ₋ₙ—CH_{w}F_{d}B_{3-w-d};
Formula II is CHₑF_{f}A_{3-e-f}-(CH₂)_{g}—(SiO)ₕC₂ₕH₆ₕ—SiC₂H₆—(CH₂)ᵢ—CHⱼFₖB₃₋ⱼ₋ₖ;
wherein C is carbon, H is hydrogen, F is fluorine, O is oxygen, Si is silicon;
wherein A is one of a cyano group, an amino group, a secondary amino group, a tertiary amino group, a carboxyl group, an oxhydryl group, a sulfonyl group

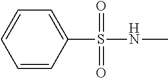

group and an acylamino group;
wherein B is one of a cyano group, an amino group, a secondary amino group, a tertiary amino group, a carboxyl group, an oxhydryl group, a sulfonyl group,

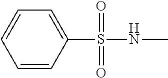

and an acylamino group;
whereby a, b, w, d, m, n, e, f, g, h, i, j and k are integers; a, b, w, d, n, e, f, g, i, j and k are ≥0; 3-a-b>0, 3-w-d≥0, 2m-n≥0, 0≤m≤10; 3-e-f>0, 3-j-k≥0, h≥1, and 2h+g+i≤9.

In one embodiment, when the general formula of the positive pole protector is Formula I, 0≤m≤6; and, when the general formula of the positive pole protector is Formula II, 2≤2h+g+i≤6.

In yet another embodiment, when the general formula of the positive pole protector is Formula I, 3-a-b=1 and 3-w-d≤1; and when the general formula is Formula II, 3-e-f=1 and 3-j-k≤1.

In a specific embodiment, when the general formula of the positive pole protector is Formula I, 3-a-b=1 and 3-w-d=1; and when the general formula of the positive pole protector is Formula II, 3-e-f=1 and 3-j-k=1.

The positive pole material according to claim 5, wherein when the general formula of the positive pole protector is Formula I, b=0, n=0 and d=0; and when the general formula of the positive pole protector is Formula II, f=0 and k=0.

In one embodiment, the general formula of the positive pole protector is Formula I.

In one embodiment, the —CₘFₙH₂ₘ₋ₙ— in Formula I is a straight chain.

In a specific embodiment, A and B are the same chelation groups.

In one embodiment, A is one of a cyano group, an acylamino group, an oxhydryl group and a carboxyl group; and B is one of a cyano group, an acylamino group, an oxhydryl group and a carboxyl group.

In a specific embodiment, the positive pole protector is one of n-butyronitrile, butanedinitrile, n-butylamine, butanediamine, n-pentanenitrile, isovaleronitrile, glutaronitrile, n-amylamine, isoamylamine, pentamethylene diamine, hexanenitrile, isocapronitrile, 1,4-dicyanobutane, n-hexylamine, iso-hexylamine, 1,4-diaminobutane, heptanenitrile, 1,5-dicyanopentane, n-heptylamine, 1,5-diaminopentane, n-heptyl cyanide, 1,6-dicyanohexane, n-octylamine, 1,6-diamino-hexane, nonanonitrile, 1,7-dicyanoheptane, nonylamine, 1,7-diaminoheptane, decanenitrile, 1,8-dicyanooctane, n-decylamine, 1,8-diaminooctane, 4-[[3-cyanopropyl(dimethyl)silyl]oxy-dimethylsilyl]butanenitrile, octylene glycol, sebacic acid, N-butyl benzenesulfonamide, butanediamide and 2,2,3,3,4,4,4-heptafluorobutylamine.

In one embodiment, the positive pole protector is butanedinitrile, n-octylamine or glutaronitrile.

The positive pole material in the present disclosure comprises the positive pole protector, a positive pole active material, an adhesive and a conductive agent. In one embodiment, the addition of the positive pole protector is from about 0.01 wt % to about 10 wt % of the positive pole active material. In another embodiment, the addition of positive pole protector is from about 0.05 wt % to about 5 wt % of the positive pole active material. In a specific embodiment, the addition of the positive pole protector is from about 0.1 wt % to about 1 wt % of the positive pole active material.

The disclosure introduces a positive pole.

The positive pole comprises a positive pole current collector and a positive pole material, wherein the positive pole material contains positive pole protector.

The disclosure also introduces a battery.

The battery comprises an electrolyte, a negative pole, and a positive pole, wherein the positive pole is made of the positive pole material containing the positive pole protector of the present invention.

The present disclosure also provides a battery pack. The battery pack comprises the batteries in series or in parallel.

The present disclosure provides the following advantages:

(1) By adding the positive pole protector in the disclosure to the manganese-based positive pole, battery capacity attenuation can be effectively prevented and the cycling stability during charging and discharging can be enhanced. (2) These protective additives can keep the battery performance well for a long time, ensuring high efficiency, safety and low cost. (3) The positive pole protector in the disclosure is pretty ideal for use on compact power sources.

Additional features and benefits of the present invention will become apparent from the detailed description, figures and claims set forth below.

### BRIEF DESCRIPTION OF THE DRAWINGS

These and other features, aspects, and advantages of the present invention will become better understood with reference to the following description, appended claims and accompanying drawings where:

FIG. 1 is a schematic diagram of a positive pole protector according to an embodiment of the present disclosure.

FIG. 2 illustrates an example of how the positive pole protector herein inhibits manganese ion dissolution and water decomposition according to an embodiment of the present invention.

FIG. 3 shows a graph comparing the cycle life performance of a conventional battery with the positive pole materials additive as illustrated in Examples 1 and 2 and References 1 and 2 according to an embodiment of the present disclosure.

FIG. 4 shows a graph comparing the cycle life performance of a conventional battery with the positive pole materials additive as illustrated in Examples 3, 4, 5, 6 and 7 according to an embodiment of the present disclosure.

FIG. 5 shows a graph comparing the cycle life performance of a conventional battery with the positive pole materials additive as illustrated in Examples 8 and 9 according to an embodiment of the present disclosure.

FIG. 6 shows a graph comparing the cycle life performance of a conventional battery with the positive pole materials additive as illustrated in Examples 10, 11 and 12 according to an embodiment of the present disclosure.

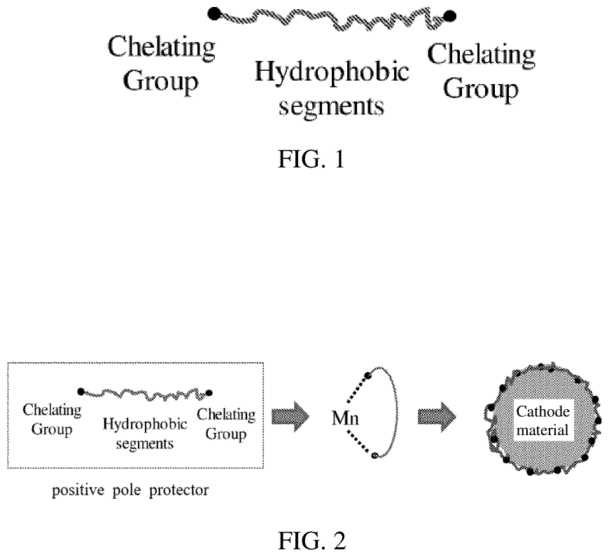

These and other features, aspects, and advantages of the present invention will become better understood with reference to the following description.

### DETAILED DESCRIPTION OF EMBODIMENTS

In the descriptions presented below, a positive pole material, comprising a positive pole protector in the disclosure is provided. The positive pole protector preferably is a compound containing both a hydrophobic chain and a chelation group; the hydrophobic chain comprises at least one of an alkyl chain, a siloxy chain and a fluoroalkyl chain; and the chelation group comprises at least one of a cyano group, an amino group, a secondary amino group, a tertiary amino group, a carboxyl group, an oxhydryl group, a sulfonyl group and an acylamino group.

The chelation group is believed to function by chelating metal ions. According to a preferred embodiment of the present disclosure, the chelating group is present in a sufficient amount to remove undesirable metal ions.

Due to the combination of chelation groups and metal ions (such as Mn³⁺, Mn⁴⁺), the positive pole protector herein can be firmly absorbed on the positive pole, and then a hydrophobic layer can be formed on the positive pole as well with the help of hydrophobic groups on the other side. The hydrophobic layer in turn reduces the effective contact area between the water and the positive pole, which will further decrease water decomposition, positive pole disproportionation and other side reactions for the sake of improving the cycling effect.

In accordance with the present disclosure, the positive pole protector herein shall contain both a hydrophobic chain and a chelation group. If the positive pole protector applied on the aqueous zinc battery does not have a chelation group, independent hydrophobic chain molecules will tend to fuse together to reduce interfacial energy due to interfacial tension of the aqueous electrolyte, rather than cover the positive pole material, so that the positive pole material may not be protected.

According to a preferred embodiment of the present invention, the number of backbone atoms on the hydrophobic chain is between about 2 and about 12 atoms.

Particularly, when the hydrophobic chain is an alkyl chain or a fluoroalkyl chain, the number of backbone atoms refers to the number of backbone carbon atoms; when the hydrophobic chain is a siloxy chain, the number of backbone atoms refers to the total number of silicon atoms and oxygen atoms on the backbone; when the hydrophobic chain contains both an alkyl chain and a siloxy chain, the number of backbone atoms refers to the sum of carbon atoms, silicon atoms and oxygen atoms on the backbone; when the hydrophobic chain contains a fluoroalkyl chain and a siloxy chain, the number of backbone atoms refers to the sum of carbon atoms, silicon atoms and oxygen atoms on the backbone; when the hydrophobic chain contains an alkyl chain, a fluoroalkyl chain and a siloxy chain, the number of backbone atoms also refers to the sum of carbon atoms, silicon atoms and oxygen atoms on the backbone.

Preferably, the length of the hydrophobic chain is limited. If the hydrophobic chain is too long, the additive may be unable to disperse the positive pole paste, resulting in a worse cycling performance. In an embodiment of the present disclosure, the number of backbone atoms on the hydrophobic chain is between about 2 and about 9. According to another preferable embodiment, the number of backbone atoms on the hydrophobic chain is between about 2 and about 8.

Typically, in an embodiment of the present disclosure, the hydrophobic chain comprises at least one of an alkyl chain and a fluoroalkyl chain, and the chelation group comprises at least one of a cyano group, an amino group, a secondary amino group, a tertiary amino group, a carboxyl group, an oxhydryl group, a sulfonyl group and an acylamino group.

In a preferred embodiment of the present disclosure, the hydrophobic chain is one of a siloxy chain, an alkyl chain and a fluoroalkyl chain, and the chelation group is one of a cyano group, an amino group, a secondary amino group, a tertiary amino group, a carboxyl, an oxhydryl, a sulfonyl and an acylamino.

In one embodiment, the hydrophobic chain is a straight chain.

In a specific embodiment, the general formula of the positive pole protector is shown in Formula I or II;

Formula I is CHₐF_{b}A_{3-a-b}-CₘFₙH₂ₘ₋ₙ—CH_{w}F_{d}B_{3-w-d};
Formula II is CHₑF_{f}A_{3-e-f}-(CH₂)_{g}—(SiO)ₕC₂ₕH₆ₕ—SiC₂H₆—(CH₂)ᵢ—CHⱼFₖB₃₋ⱼ₋ₖ;
where, C is carbon, H is hydrogen, F is fluorine, O is oxygen, Si is silicon, A is one of a cyano group, an amino group, a secondary amino group, a tertiary amino group, a carboxyl group, an oxhydryl group, a sulfonyl group,

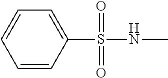

and an acylamino group; B is one of a cyano group, an amino group, a secondary amino group, a tertiary amino group, a carboxyl group, an oxhydryl group, a sulfonyl group,

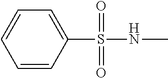

and an acylamino group; where a, b, w, d, m, n, e, f, g, h, i, j and k are integers; a, b, w, d, n, e, f, g, i, j and k are ≥0; 3-a-b>0, 3-w-d≥0, 2m-n≥0, 0≤m≤10, 3-e-f>0, 3-j-k≥0, h≥1, and 2h+g+i≤9.

In one embodiment: When the general formula of the positive pole protector is Formula I, 0≤m≤8; and when the general formula of the positive pole protector is Formula II, 2≤2h+g+i≤6.

In another embodiment: When the general formula of the positive pole protector is Formula I, 0≤m≤6.

In one embodiment: When the general formula is Formula I, 3-a-b=1 and 3-w-d≤1; and when the general Formula Is Formula II, 3-e-f=1 and 3-j-k≤1.

In a specific embodiment: When the general formula is Formula I, 3-a-b=1 and 3-w-d=1; when the general formula is Formula II, 3-e-f=1 and 3-j-k=1; and the cycling performance of the battery will be better when the molecule of positive pole protector contains two chelation groups.

In a specific embodiment: When the general formula is Formula I, b=0, n=0 and d=0; and when the general Formula Is Formula II, f=0 and k=0.

In one embodiment: The general formula of the positive pole protector is Formula I.

In one embodiment: The —CₘFₙH₂ₘ₋ₙ₋ in Formula I is a straight chain.

In a specific embodiment: A and B are the same chelation groups.

In one embodiment: A is one of a cyano group, an acylamino group, an oxhydryl group and a carboxyl group, and B is one of a cyano group, an acylamino group, an oxhydryl group and a carboxyl group.

In a specific embodiment of the present disclosure, the positive pole protector is one of n-butyronitrile, butanedinitrile, n-butylamine, butanediamine, n-pentanenitrile, isovaleronitrile, glutaronitrile, n-amylamine, isoamylamine, pentamethylene diamine, hexanenitrile, isocapronitrile, 1,4-dicyanobutane, n-hexylamine, iso-hexylamine, 1,4-diaminobutane, heptanenitrile, 1,5-dicyanopentane, n-heptylamine, 1,5-diaminopentane, n-heptyl cyanide, 1,6-dicyanohexane, n-octylamine, 1,6-diamino-hexane, nonanonitrile, 1,7-dicyanoheptane, nonylamine, 1,7-diaminoheptane, decanenitrile, 1,8-dicyanooctane, n-decylamine, 1,8-diaminooctane, 4-[[3-cyanopropyl(dimethyl)silyl]oxy-dimethylsilyl]butanenitrile, octylene glycol, sebacic acid, N-butyl benzenesulfonamide, butanediamide and 2,2,3,3,4,4,4-heptafluorobutylamine.

In one embodiment of the present disclosure, the positive pole protector is butanedinitrile, n-octylamine or glutaronitrile.

According to an embodiment of the present disclosure, the positive pole material comprises a positive pole protector, a positive pole active material, an adhesive and a conductive agent.

In one embodiment, the positive pole active material refers to manganese-based positive pole material; in another embodiment, the positive pole active material contains at least one material with the formula as Li₁₊ₚMn_{y}MᵤOᵥ, where M is at least one of Na, Li, Co, Mg, Ti, Cr, V, Zn, Zr, Si and Al (−1≤p≤0.5, 1≤y≤2.5, 0≤u≤1, 3≤v≤6); in a specific embodiment, the positive pole active material contains at least one of LiMn₂O₄ and MnO₂. In a specific embodiment, the positive pole active material refers to LiMn₂O₄.

Typically, the adhesive is a polymeric compound used to stick an electrode active material to a current collector. It aims to bond and retain active substances, increase electronic contact between the surfaces of electrode active material/conductive agent and active material/current collector, and fix the structure of the electrode better.

The adhesive in the disclosure can be any existing conventional adhesive and can be obtained from a commercial source known to those skilled in the art. In one embodiment, the adhesive may comprise at least one of polyethylene oxide, Poly[oxy(methyl-1,2-ethanediyl)], polyacrylonitrile, polyimide, polyester, polyether, fluorinated polymer, polydiethylene glycol, polyethylene glycol diacrylate Poly(ethylene glycol) dimethacrylate and its derivatives, polyvinylidene fluoride, polytetrafluoroethylene and styrene-butadiene rubber.

In one embodiment, the positive pole further comprises a conductive agent. The conductive agent may be any existing conventional one and can be obtained from a commercial source known to those skilled in the art. In another embodiment, the conductive agent may comprise at least one of activated carbon, carbon black, graphene, graphite, carbon nanotube, carbon fiber and conductive polymer; in a specific embodiment, it comprises at least one of activated carbon, carbon black, graphene and carbon nanotube.

Preferably in one embodiment of the present disclosure, the addition of the positive pole protector is from about 0.01 wt % to about 10 wt % of the positive pole active material. More preferably, the addition of the positive pole protector is from about 0.05 wt % to about 5 wt % of the positive pole active material.

In a specific embodiment, the addition of the positive pole protector is from about 0.1 wt % to about 1 wt % of the positive pole active material. The cycle life of the battery can be improved in all these ranges.

According to an embodiment, the disclosure introduces a positive pole. The positive pole comprises a positive pole current collector and a positive pole material, where the positive pole material contains positive pole protector.

Preferably, the positive pole material exists on the positive pole current collector. The positive pole material can be formed on either one side or both sides of the positive pole current collector. The positive pole can be prepared according to any method known to those skilled in the art. For example, the positive pole can be prepared as follows: mixing the positive pole protector, positive pole active material, conductive agent, adhesive and solvent evenly, and then filtering the solution by a screen to get the paste of positive pole material; applying the paste on the positive pole current collector and drying it before cutting it into the positive pole of appropriate size.

Typically, when preparing the positive material paste, the solvent hereto may be at least one of water, alcohol, ester, carbonate, ether and ketone. In another embodiment, the solvent may also be at least one of water, ethanol, lactone and N-methyl-2-pyrrolidone.

As no special restriction is made on the positive pole current collector in the disclosure, those skilled in the art can select it according to their needs. As the carrier of electron conduction and collection, the positive pole current collector does not participate in the electrochemical reaction, that is, within the range of operating voltage of the battery, the positive pole current collector can stably exist in the electrolyte solution without side reaction, so as to ensure the stable cycle performance of the battery. The size of the positive pole current collector can be determined according to the use of the battery. For example, a large-area positive pole current collector can be used for a large battery that requires a high energy density. There is no special restriction on the thickness of the positive pole current collector, usually about 1-100 μm. There is also no special restriction on the shape of the positive pole current collector. It can be either a rectangle or a circle. There is no special restriction on the materials of the positive pole current collector. For example, metal, alloy or carbon-based materials can be used.

In one embodiment, the positive pole current collector is at least one of aluminum, iron, copper, lead, titanium, silver, cobalt, aluminum alloy, stainless steel, copper alloy and titanium alloy; in another embodiment, it is aluminum, titanium, aluminum alloy or stainless steel.

According to yet another embodiment, the disclosure introduces a battery. The battery comprises an electrolyte, a negative pole and a positive pole, where the positive pole contains the positive pole protector.

Typically, the negative pole may include a negative pole current collector and a negative pole active substance. No special restriction is made on the negative pole current collector. Therefore, the negative pole current collector can be made either from at least one of Ni, Cu, Ag, Pb, Mn, Sn, Fe, Al, brass and any passivated metal above, or from silicon, carbon-based materials, stainless steel and passivated stainless steel. A negative pole active metal sheet may be directly used as both current collector and negative pole active metal.

Typically, the negative pole active substance exists on the negative pole current collector. The negative pole active substance can be formed on one or both sides of the positive pole current collector. As no special restriction is made on the negative pole active substance in the disclosure, those skilled in the art can select it according to their needs.

In one embodiment, the negative pole refers to a zinc-based electrode. This means the negative pole active substance is made from Zinc.

In another embodiment, the zinc sheet is directly used as the negative pole, which serves as both the negative pole current collector and the negative pole active substance. At this time, the zinc sheet is the carrier for negative pole charging and discharging.

In one embodiment, an aqueous solution with lithium sulfate and zinc sulfate is used as the aqueous electrolyte.

In a specific embodiment, the battery comprises a manganese-based electrode as the positive pole and zinc electrode as the negative pole, as well as an aqueous solution with lithium sulfate and zinc sulfate as the electrolyte, thus forming a zinc-manganese battery.

According to an embodiment of the present disclosure, the battery does not necessarily contain a diaphragm. Although typically, in order to provide better safety performance, there is included a diaphragm between the positive pole and the negative pole in the electrolyte. The diaphragm can avoid short circuits caused by connection between positive and negative poles due to other unexpected factors.

There are no special requirements for the diaphragm of the disclosure, as long as it allows electrolyte solution and ions to pass through and is electronically insulated. Any diaphragms for organic lithium-ion batteries known to those skilled in the art, can be applied in the present disclosure. Typically, the diaphragm allows the transport of at least some ions, including zinc ions, between the electrodes. Preferably, the diaphragm can inhibit and/or prevent the formation of dendrites and the short circuit of batteries. The diaphragm may be porous material and can be obtained from any commercial source. It can be selected from at least one of glass fiber, non-woven fabric, asbestos film, non-woven polyethylene film, nylon, polyethylene, polypropylene, polyvinylidene fluoride, polyacrylonitrile, polyethylene/polypropylene diaphragm and polypropylene/polyethylene/polypropylene diaphragm.

The disclosure also introduces a battery pack.

The battery pack comprises the batteries in series or in parallel.

The detailed embodiments of the present disclosure are described in combination with the examples, but the disclosure will thereby not be limited to the embodiments.

In the following examples and references, the zinc plates, titanium foils, diaphragms and electrolytes used are the same. Where, the electrolyte refers to an aqueous solution with zinc sulfate and lithium sulfate, including 2.1 mol/L of zinc sulfate and 1.3 mol/L of lithium sulfate.

### EXAMPLES

### Example 1

150 g of LiMn₂O₄, 3.2 g of carbon black, 6.6 g of styrene-butadiene rubber, 0.45 g of octylamine and water were mechanically stirred and mixed under 1500 rpm for 2 hours. Then filtering the mixture via a screen to obtain the positive pole paste. Applying the paste on the titanium foil, after drying, cutting it into 44.5 mm×73.5 mm, so as to get the positive pole. Then integrating the positive pole, zinc plate (negative pole), electrolyte and diaphragm into a battery unit, and soaking the battery unit in the electrolyte for 12 h under reduced pressure. After soaking, putting the battery unit into an aluminum-plastic bag and sealing, and then carrying out charge-discharge test.

The charge-discharge test for cycling performance is conducted as per the following procedures:

a. Charging procedure: charging the 0.5 C battery to 2.05V under constant current and then to 0.05 C under constant voltage, standing for 3 minutes; b. Discharging procedure: discharging the 0.5 C battery to 1.4V under constant current, standing for 3 minutes; c. Repeating steps a and b.

The initial discharging capacity of the battery unit is 96 mAh/g, and the battery unit maintains 80% capacity for 200 cycles at a charging/discharging rate of 0.5 C.

### Example 2

Mixing 150 g LiMn₂O₄, 3.2 g carbon black, 6.6 g styrene-butadiene rubber, 0.45 g 1,8-diaminooctane and water, and mechanically stirring them at 1500 rpm for 2 h. Then filtering the mixture via a screen to obtain the positive pole paste. Applying the paste on the titanium foil, after drying, cutting it into 44.5 mm×73.5 mm, so as to get the positive pole. Then integrating the positive pole, zinc plate (negative pole), electrolyte and diaphragm into a battery unit, and soaking the battery unit in the electrolyte for 12 h under reduced pressure. After soaking, putting the battery unit into an aluminum-plastic bag and sealing, and then carrying out charge-discharge test.

The charge-discharge test for cycling performance is conducted as per the following procedures:

a. Charging procedure: charging the 0.5 C battery to 2.05V under constant current and then to 0.05 C under constant voltage, standing for 3 minutes; b. Discharging procedure: discharging the 0.5 C battery to 1.4V under constant current, standing for 3 minutes; c. Repeating steps a and b.

The initial discharging capacity of the battery unit is 89 mAh/g, and the battery unit maintains 80% capacity for 202 cycles at a charging/discharging rate of 0.5 C.

### Example 3

Mixing 150 g LiMn₂O₄, 3.2 g carbon black, 6.6 g styrene-butadiene rubber, 0.45 g butanedinitrile and water, and mechanically stirring them at 1500 rpm for 2 h. Then filtering the mixture via a screen to obtain the positive pole paste. Applying the paste on the titanium foil, after drying, cutting it into 44.5 mm×73.5 mm, so as to get the positive pole. Then integrating the positive pole, zinc plate (negative pole), electrolyte and diaphragm into a battery unit, and soaking the battery unit in the electrolyte for 12 h under reduced pressure. After soaking, putting the battery unit into an aluminum-plastic bag and sealing, and then carrying out charge-discharge test.

The charge-discharge test for cycling performance is conducted as per the following procedures: a. Charging procedure: charging the 0.5 C battery to 2.05V under constant current and then to 0.05 C under constant voltage, standing for 3 minutes; b. Discharging procedure: discharging the 0.5 C battery to 1.4V under constant current, standing for 3 minutes; c. Repeating steps a and b.

The initial discharging capacity of the battery unit is 84 mAh/g, and the battery unit maintains 80% capacity for 288 cycles at a charging/discharging rate of 0.5 C.

### Example 4

Mixing 150 g LiMn₂O₄, 3.2 g carbon black, 6.6 g styrene-butadiene rubber, 0.45 g sebacic acid and water, and mechanically stirring them at 1500 rpm for 2 h. Then filtering the mixture via a screen to obtain the positive pole paste. Applying the paste on the titanium foil, after drying, cutting it into 44.5 mm×73.5 mm, so as to get the positive pole. Then integrating the positive pole, zinc plate (negative pole), electrolyte and diaphragm into a battery unit, and soaking the battery unit in the electrolyte for 12 h under reduced pressure. After soaking, putting the battery unit into an aluminum-plastic bag and sealing, and then carrying out charge-discharge test.

The charge-discharge test for cycling performance is conducted as per the following procedures: a. Charging procedure: charging the 0.5 C battery to 2.05V under constant current and then to 0.05 C under constant voltage, standing for 3 minutes; b. Discharging procedure: discharging the 0.5 C battery to 1.4V under constant current, standing for 3 minutes; c. Repeating steps a and b.

The discharging capacity of the battery unit is 88 mAh/g, and the battery unit maintains 80% capacity for 271 cycles at a charging/discharging rate of 0.5 C.

### Example 5

Mixing 150 g LiMn₂O₄, 3.2 g carbon black, 6.6 g styrene-butadiene rubber, 0.45 g octylene glycol and water, and mechanically stirring them at 1500 rpm for 2 h. Then filtering the mixture via a screen to obtain the positive pole paste. Applying the paste on the titanium foil, after drying, cutting it into 44.5 mm×73.5 mm, so as to get the positive pole. Then integrating the positive pole, zinc plate (negative pole), electrolyte and diaphragm into a battery unit, and soaking the battery unit in the electrolyte for 12 h under reduced pressure. After soaking, putting the battery unit into an aluminum-plastic bag and sealing, and then carrying out charge-discharge test.

The charge-discharge test for cycling performance is conducted as per the following procedures: a. Charging procedure: charging the 0.5 C battery to 2.05V under constant current and then to 0.05 C under constant voltage, standing for 3 minutes; b. Discharging procedure: discharging the 0.5 C battery to 1.4V under constant current, standing for 3 minutes; c. Repeating steps a and b.

The initial discharging capacity of the battery unit is 89 mAh/g, and the battery unit maintains 80% capacity for 232 cycles at a charging/discharging rate of 0.5 C.

### Example 6

Mixing 150 g LiMn₂O₄, 3.2 g carbon black, 6.6 g styrene-butadiene rubber, 0.45 g N-butyl benzenesulfonamide and water, and mechanically stirring them at 1500 rpm for 2 h. Then filtering the mixture via a screen to obtain the positive pole paste. Applying the paste on the titanium foil, after drying, cutting it into 44.5 mm×73.5 mm, so as to get the positive pole. Then integrating the positive pole, zinc plate (negative pole), electrolyte and diaphragm into a battery unit, and soaking the battery unit in the electrolyte for 12 h under reduced pressure. After soaking, putting the battery unit into an aluminum-plastic bag and sealing, and then carrying out charge-discharge test.

The charge-discharge test for cycling performance is conducted as per the following procedures: a. Charging procedure: charging the 0.5 C battery to 2.05V under constant current and then to 0.05 C under constant voltage, standing for 3 minutes; b. Discharging procedure: discharging the 0.5 C battery to 1.4V under constant current, standing for 3 minutes; c. Repeating steps a and b.

The initial discharging capacity of the battery unit is 82 mAh/g, and the battery unit maintains 80% capacity for 208 cycles at a charging/discharging rate of 0.5 C.

### Example 7

Mixing 150 g LiMn₂O₄, 3.2 g carbon black, 6.6 g styrene-butadiene rubber, 0.45 g butanediamide and water, and mechanically stirring them at 1500 rpm for 2 h. Then filtering the mixture via a screen to obtain the positive pole paste. Applying the paste on the titanium foil, after drying, cutting it into 44.5 mm×73.5 mm, so as to get the positive pole. Then integrating the positive pole, zinc plate (negative pole), electrolyte and diaphragm into a battery unit, and soaking the battery unit in the electrolyte for 12 h under reduced pressure. After soaking, putting the battery unit into an aluminum-plastic bag and sealing, and then carrying out charge-discharge test.

The charge-discharge test for cycling performance is conducted as per the following procedures: a. Charging procedure: charging the 0.5 C battery to 2.05V under constant current and then to 0.05 C under constant voltage, standing for 3 minutes; b. Discharging procedure: discharging the 0.5 C battery to 1.4V under constant current, standing for 3 minutes; c. Repeating steps a and b.

The initial discharging capacity of the battery unit is 86 mAh/g, and the battery unit maintains 80% capacity for 249 cycles at a charging/discharging rate of 0.5 C.

### Example 8

Mixing 150 g LiMn₂O₄, 3.2 g carbon black, 6.6 g styrene-butadiene rubber, 0.45 g 4-[[3-cyanopropyl(dimethyl)silyl]oxy-dimethylsilyl]butanenitrile and water, and mechanically stirring them at 1500 rpm for 2 h. Then filtering the mixture via a screen to obtain the positive pole paste. Applying the paste on the titanium foil, after drying, cutting it into 44.5 mm×73.5 mm, so as to get the positive pole. Then integrating the positive pole, zinc plate (negative pole), electrolyte and diaphragm into a battery unit, and soaking the battery unit in the electrolyte for 12 h under reduced pressure. After soaking, putting the battery unit into an aluminum-plastic bag and sealing, and then carrying out charge-discharge test.

The charge-discharge test for cycling performance is conducted as per the following procedures: a. Charging procedure: charging the 0.5 C battery to 2.05V under constant current and then to 0.05 C under constant voltage, standing for 3 minutes; b. Discharging procedure: discharging the 0.5 C battery to 1.4V under constant current, standing for 3 minutes; c. Repeating steps a and b.

The initial discharging capacity of the battery unit is 97 mAh/g, and the battery unit maintains 80% capacity for 229 cycles at a charging/discharging rate of 0.5 C.

### Example 9

Mixing 150 g LiMn₂O₄, 3.2 g carbon black, 6.6 g styrene-butadiene rubber, 0.45 g 2,2,3,3,4,4,4-heptafluorobutylamine and water, and mechanically stirring them at 1500 rpm for 2 h. Then filtering the mixture via a screen to obtain the positive pole paste. Applying the paste on the titanium foil, after drying, cutting it into 44.5 mm×73.5 mm, so as to get the positive pole. Then integrating the positive pole, zinc plate (negative pole), electrolyte and diaphragm into a battery unit, and soaking the battery unit in the electrolyte for 12 h under reduced pressure. After soaking, putting the battery unit into an aluminum-plastic bag and sealing, and then carrying out charge-discharge test.

The charge-discharge test for cycling performance is conducted as per the following procedures: a. Charging procedure: charging the 0.5 C battery to 2.05V under constant current and then to 0.05 C under constant voltage, standing for 3 minutes; b. Discharging procedure: discharging the 0.5 C battery to 1.4V under constant current, standing for 3 minutes; c. Repeating steps a and b.

The initial discharging capacity of the battery unit is 83 mAh/g, and the battery unit maintains 80% capacity for 227 cycles at a charging/discharging rate of 0.5 C.

### Example 10

Mixing 150 g LiMn₂O₄, 3.2 g carbon black, 6.6 g styrene-butadiene rubber, 0.15 g butanedinitrile and water, and mechanically stirring them at 1500 rpm for 2 h. Then filtering the mixture via a screen to obtain the positive pole paste. Applying the paste on the titanium foil, after drying, cutting it into 44.5 mm×73.5 mm, so as to get the positive pole. Then integrating the positive pole, zinc plate (negative pole), electrolyte and diaphragm into a battery unit, and soaking the battery unit in the electrolyte for 12 h under reduced pressure. After soaking, putting the battery unit into an aluminum-plastic bag and sealing, and then carrying out charge-discharge test.

The charge-discharge test for cycling performance is conducted as per the following procedures: a. Charging procedure: charging the 0.5 C battery to 2.05V under constant current and then to 0.05 C under constant voltage, standing for 3 minutes; b. Discharging procedure: discharging the 0.5 C battery to 1.4V under constant current, standing for 3 minutes; c. Repeating steps a and b.

The initial discharging capacity of the battery unit is 85 mAh/g, and the battery unit maintains 80% capacity for 245 cycles at a charging/discharging rate of 0.5 C.

### Example 11

Mixing 150 g LiMn₂O₄, 3.2 g carbon black, 6.6 g styrene-butadiene rubber, 0.75 g butanedinitrile and water, and mechanically stirring them at 1500 rpm for 2 h. Then filtering the mixture via a screen to obtain the positive pole paste. Applying the paste on the titanium foil, after drying, cutting it into 44.5 mm×73.5 mm, so as to get the positive pole. Then integrating the positive pole, zinc plate (negative pole), electrolyte and diaphragm into a battery unit, and soaking the battery unit in the electrolyte for 12 h under reduced pressure. After soaking, putting the battery unit into an aluminum-plastic bag and sealing, and then carrying out charge-discharge test.

The charge-discharge test for cycling performance is conducted as per the following procedures: a. Charging procedure: charging the 0.5 C battery to 2.05V under constant current and then to 0.05 C under constant voltage, standing for 3 minutes; b. Discharging procedure: discharging the 0.5 C battery to 1.4V under constant current, standing for 3 minutes; c. Repeating steps a and b.

The initial discharging capacity of the battery unit is 84 mAh/g, and the battery unit maintains 80% capacity for 244 cycles at a charging/discharging rate of 0.5 C.

### Example 12

Mixing 150 g LiMn₂O₄, 3.2 g carbon black, 6.6 g styrene-butadiene rubber, 1.5 g butanedinitrile and water, and mechanically stirring them at 1500 rpm for 2 h. Then filtering the mixture via a screen to obtain the positive pole paste. Applying the paste on the titanium foil, after drying, cutting it into 44.5 mm×73.5 mm, so as to get the positive pole. Then integrating the positive pole, zinc plate (negative pole), electrolyte and diaphragm into a battery unit, and soaking the battery unit in the electrolyte for 12 h under reduced pressure. After soaking, putting the battery unit into an aluminum-plastic bag and sealing, and then carrying out charge-discharge test.

The charge-discharge test for cycling performance is conducted as per the following procedures: a. Charging procedure: charging the 0.5 C battery to 2.05V under constant current and then to 0.05 C under constant voltage, standing for 3 minutes; b. Discharging procedure: discharging the 0.5 C battery to 1.4V under constant current, standing for 3 minutes; c. Repeating steps a and b.

The initial discharging capacity of the battery unit is 91 mAh/g, and the battery unit maintains 80% capacity for 270 cycles at a charging/discharging rate of 0.5 C.

Reference 1

Mixing 150 g LiMn₂O₄, 3.2 g carbon black, 6.6 g styrene-butadiene rubber and water, and mechanically stirring them at 1500 rpm for 2 h. Then filtering the mixture via a screen to obtain the positive pole paste. Applying the paste on the titanium foil, after drying, cutting it into 44.5 mm×73.5 mm, so as to get the positive pole. Then integrating the positive pole, zinc plate (negative pole), electrolyte and diaphragm into a battery unit, and soaking the battery unit in the electrolyte for 12 h under reduced pressure. After soaking, putting the battery unit into an aluminum-plastic bag and sealing, and then carrying out charge-discharge test.

The charge-discharge test for cycling performance is conducted as per the following procedures: a. Charging procedure: charging the 0.5 C battery to 2.05V under constant current and then to 0.05 C under constant voltage, standing for 3 minutes; b. Discharging procedure: discharging the 0.5 C battery to 1.4V under constant current, standing for 3 minutes; c. Repeating steps a and b.

The initial discharging capacity of the battery unit is 90 mAh/g, and the battery unit maintains 80% capacity for 183 cycles at a charging/discharging rate of 0.5 C.

Reference 2

Mixing 150 g LiMn₂O₄, 3.2 g carbon black, 6.6 g styrene-butadiene rubber, 0.45 g n-octane and water, and mechanically stirring them at 1500 rpm for 2 h. Then filtering the mixture via a screen to obtain the positive pole paste. Applying the paste on the titanium foil, after drying, cutting it into 44.5 mm×73.5 mm, so as to get the positive pole. Then integrating the positive pole, zinc plate (negative pole), electrolyte and diaphragm into a battery unit, and soaking the battery unit in the electrolyte for 12 h under reduced pressure. After soaking, putting the battery unit into an aluminum-plastic bag and sealing, and then carrying out charge-discharge test.

The charge-discharge test for cycling performance is conducted as per the following procedures: a. Charging procedure: charging the 0.5 C battery to 2.05V under constant current and then to 0.05 C under constant voltage, standing for 3 minutes; b. Discharging procedure: discharging the 0.5 C battery to 1.4V under constant current, standing for 3 minutes; c. Repeating steps a and b.

The initial discharging capacity of the battery unit is 99 mAh/g, and the battery unit maintains 80% capacity for 181 cycles at a charging/discharging rate of 0.5 C.

Reference 3

Mixing 150 g LiMn₂O₄, 3.2 g carbon black, 6.6 g styrene-butadiene rubber, 0.45 g y-mercaptopropyltrimethoxysilane and water, and mechanically stirring them at 1500 rpm for 2 h. Then filtering the mixture via a screen to obtain the positive pole paste. Applying the paste on the titanium foil, after drying, cutting it into 44.5 mm×73.5 mm, so as to get the positive pole. Then integrating the positive pole, zinc plate (negative pole), electrolyte and diaphragm into a battery unit, and soaking the battery unit in the electrolyte for 12 h under reduced pressure. After soaking, putting the battery unit into an aluminum-plastic bag and sealing, and then carrying out charge-discharge test.

The charge-discharge test for cycling performance is conducted as per the following procedures: a. Charging procedure: charging the 0.5 C battery to 2.05V under constant current and then to 0.05 C under constant voltage, standing for 3 minutes; b. Discharging procedure: discharging the 0.5 C battery to 1.4V under constant current, standing for 3 minutes; c. Repeating steps a and b.

The initial discharging capacity of the battery unit is 99 mAh/g, and the battery unit maintains 80% capacity for 201 cycles at a charging/discharging rate of 0.5 C.

Reference 4

Mixing 150 g LiMn₂O₄, 3.2 g carbon black, 6.6 g styrene-butadiene rubber, 0.45 g 1,3-bis(4-pyridyl)propane and water, and mechanically stirring them at 1500 rpm for 2 h. Then filtering the mixture via a screen to obtain the positive pole paste. Applying the paste on the titanium foil, after drying, cutting it into 44.5 mm×73.5 mm, so as to get the positive pole. Then integrating the positive pole, zinc plate (negative pole), electrolyte and diaphragm into a battery unit, and soaking the battery unit in the electrolyte for 12 h under reduced pressure. After soaking, putting the battery unit into an aluminum-plastic bag and sealing, and then carrying out charge-discharge test.

The charge-discharge test for cycling performance is conducted as per the following procedures: a. Charging procedure: charging the 0.5 C battery to 2.05V under constant current and then to 0.05 C under constant voltage, standing for 3 minutes; b. Discharging procedure: discharging the 0.5 C battery to 1.4V under constant current, standing for 3 minutes; c. Repeating steps a and b.

The initial discharging capacity of the battery unit is 73 mAh/g, and the battery unit maintains 80% capacity for 129 cycles at a charging/discharging rate of 0.5 C.

Reference 5

Mixing 150 g LiMn₂O₄, 3.2 g carbon black, 6.6 g styrene-butadiene rubber, 0.45 g stearonitrile and water, and mechanically stirring them at 1500 rpm for 2 h. Then filtering the mixture via a screen to obtain the positive pole paste. Applying the paste on the titanium foil, after drying, cutting it into 44.5 mm×73.5 mm, so as to get the positive pole. Then integrating the positive pole, zinc plate (negative pole), electrolyte and diaphragm into a battery unit, and soaking the battery unit in the electrolyte for 12 h under reduced pressure. After soaking, putting the battery unit into an aluminum-plastic bag and sealing, and then carrying out charge-discharge test.

The charge-discharge test for cycling performance is conducted as per the following procedures: a. Charging procedure: charging the 0.5 C battery to 2.05V under constant current and then to 0.05 C under constant voltage, standing for 3 minutes; b. Discharging procedure: discharging the 0.5 C battery to 1.4V under constant current, standing for 3 minutes; c. Repeating steps a and b.

The initial discharging capacity of the battery unit is 84 mAh/g, and the battery unit maintains 80% capacity for 47 cycles at a charging/discharging rate of 0.5 C.

Reference 6

Mixing 150 g LiMn₂O₄, 3.2 g carbon black, 6.6 g styrene-butadiene rubber, 0.45 g 2,5,8,11,14,17,20,23,26,29,32,35-Dodecaoxaheptatriacontan-37-amine and water, and mechanically stirring them at 1500 rpm for 2 h. Then filtering the mixture via a screen to obtain the positive pole paste. Applying the paste on the titanium foil, after drying, cutting it into 44.5 mm×73.5 mm, so as to get the positive pole. Then integrating the positive pole, zinc plate (negative pole), electrolyte and diaphragm into a battery unit, and soaking the battery unit in the electrolyte for 12 h under reduced pressure. After soaking, putting the battery unit into an aluminum-plastic bag and sealing, and then carrying out charge-discharge test.

The charge-discharge test for cycling performance is conducted as per the following procedures: a. Charging procedure: charging the 0.5 C battery to 2.05V under constant current and then to 0.05 C under constant voltage, standing for 3 minutes; b. Discharging procedure: discharging the 0.5 C battery to 1.4V under constant current, standing for 3 minutes; c. Repeating steps a and b.

The initial discharging capacity of the battery unit is 87 mAh/g, and the battery unit maintains 80% capacity for 165 cycles at a charging/discharging rate of 0.5 C.

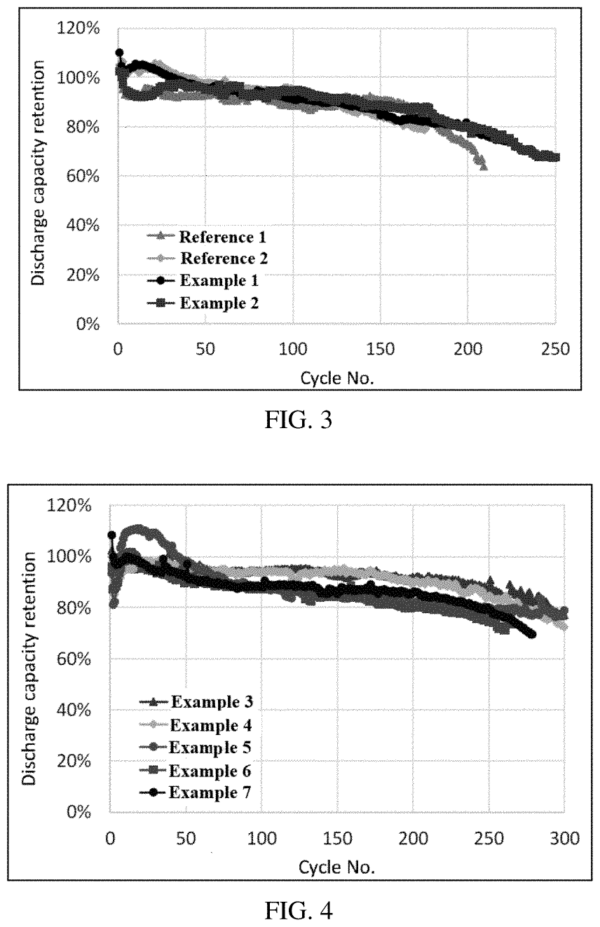

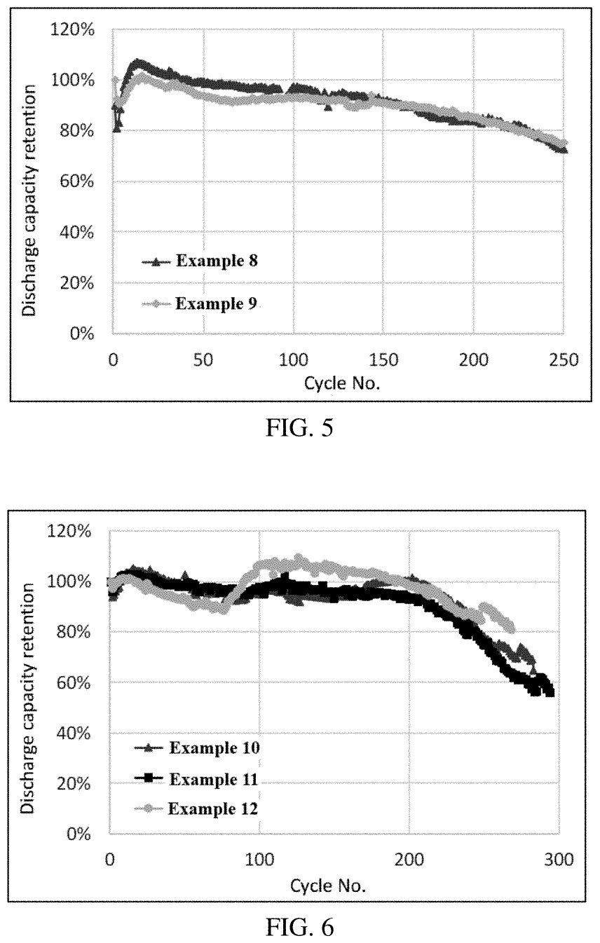

It can be seen from FIG. 3 and tests in Reference 1, Reference 2, Example 1 and Example 2 that: 1. The positive pole protector with a hydrophobic chain but no chelation group does not improve the cycling performance of the battery; 2. The positive pole protector with one or two chelation groups can both improve the cycling performance of the battery.

Tests in Reference 1, Example 3, Example 4, Example 5, Example 6, Example 7 and Reference 4 prove that cyano group, amino group, carboxyl, oxhydryl, sulfonyl and acylamino can improve the cycle life of the battery, but pyridyl will bring adverse effects on the cycle performance of the battery.

It can be seen from tests in Example 4, Reference 1, Reference 5 and Reference 6 that, if the hydrophobic chain of the positive pole protector is too long, the positive pole paste will be difficultly dispersed, and the cycling performance of the battery will be affected accordingly.

The previously described invention has many advantages. The advantages include safe, efficient, novel inexpensive cathode protective additives in aqueous rechargeable zinc batteries which offer significant protection against battery capacity fading, while enhancing cycling stability during recharging of the battery that will overcome the limitations of traditional shortened cycle life of batteries. These cathode protective additives make them especially valuable in meeting the growing demands to find compact power sources specifically with long-life solutions in grid storage.

Throughout the description and drawings, example embodiments are given with reference to specific configurations. It will be appreciated by those of ordinary skill in the art that the present invention can be embodied in other specific forms. Those of ordinary skill in the art would be able to practice such other embodiments without undue experimentation. The scope of the present invention, for the purpose of the present patent document, is not limited merely to the specific example embodiments or alternatives of the foregoing description.

What is claimed is:

1. A positive pole material, comprising:
a positive pole protector comprising a compound containing a hydrophobic chain and a chelation group;
wherein the hydrophobic chain comprises at least one of an alkyl chain, a siloxy chain and a fluoroalkyl chain;
whereby the chelation group comprises at least one of a cyano group, an amino group, a secondary amino group, a tertiary amino group, a carboxyl group, an oxhydryl group, a sulfonyl group and an acylamino group.

2. The positive pole material according to claim 1, wherein the hydrophobic chain comprises a number of backbone atoms from about 2 to about 12.

3. The positive pole material according to claim 1, wherein the hydrophobic chain is at least one of an alkyl chain and a fluoroalkyl chain and,
the chelation group is at least one of a cyano group, an amino group, a secondary amino group, a tertiary amino group, a carboxyl group, an oxhydryl group, a sulfonyl group and an acylamino group.

4. The positive pole material according to claim 1, wherein the hydrophobic chain is a straight chain.

5. The positive pole material according to claim 1, wherein the general formula of the positive pole protector comprises Formula I or II;
Formula I is CHₐF_{b}A_{3-a-b}-CₘFₙH₂ₘ₋ₙ—CH_{w}F_{d}B_{3-w-d};
Formula II is CHₑF_{f}A_{3-e-f}-(CH₂)_{g}—(SiO)ₕC₂ₕH₆ₕ—SiC₂H₆—(CH₂)ᵢ—CHⱼFₖB₃₋ⱼ₋ₖ;
wherein C is carbon, H is hydrogen, F is fluorine, O is oxygen, Si is silicon;
wherein A is one of a cyano group, an amino group, a secondary amino group, a tertiary amino group, a carboxyl group, an oxhydryl group, a sulfonyl group 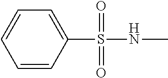
group and an acylamino group;
wherein B is one of a cyano group, an amino group, a secondary amino group, a tertiary amino group, a carboxyl group, an oxhydryl group, a sulfonyl group, 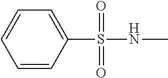
and an acylamino group;
whereby a, b, w, d, m, n, e, f, g, h, i, j and k are integers; a, b, w, d, n, e, f, g, i, j and k are ≥0; 3-a-b>0, 3-w-d≥0, 2m-n≥0, 0≤m≤10; 3-e-f>0, 3-j-k≥0, h≥1, and 2h+g+i≤9.

6. The positive pole material according to claim 5, wherein when the general formula of the positive pole protector is Formula I, 0≤m≤6; and,
when the general formula of the positive pole protector is Formula II, 2≤2h+g+i≤6.

7. The positive pole material according to claim 5, wherein when the general formula of the positive pole protector is Formula I, 3-a-b=1 and 3-w-d≤1; and when the general formula is Formula II, 3-e-f=1 and 3-j-k≤1.

8. The positive pole material according to claim 5, wherein when the general formula of the positive pole protector is Formula I, 3-a-b=1 and 3-w-d=1; and when the general formula of the positive pole protector is Formula II, 3-e-f=1 and 3-j-k=1.

9. The positive pole material according to claim 5, wherein when the general formula of the positive pole protector is Formula I, b=0, n=0 and d=0; and when the general formula of the positive pole protector is Formula II, f=0 and k=0.

10. The positive pole material according to claim 5, wherein the general formula of the positive pole protector is Formula I.

11. The positive pole material according to claim 5, wherein the —CₙFₙH₂ₘ₋ₙ₋ in Formula I is a straight chain.

12. The positive pole material according to claim 5, wherein A and B are the same chelation groups.

13. The positive pole material according to claim 5, wherein A is one of a cyano group, an acylamino group, an oxhydryl group and a carboxyl group; and B is one of a cyano group, an acylamino group, an oxhydryl group and a carboxyl group.

14. The positive pole material according to claim 1, wherein the positive pole protector is one of n-butyronitrile, butanedinitrile, n-butylamine, butanediamine, n-pentanenitrile, isovaleronitrile, glutaronitrile, n-amylamine, isoamylamine, pentamethylene diamine, hexanenitrile, isocapronitrile, 1,4-dicyanobutane, n-hexylamine, iso-hexylamine, 1,4-diaminobutane, heptanenitrile, 1,5-dicyanopentane, n-heptylamine, 1,5-diaminopentane, n-heptyl cyanide, 1,6-dicyanohexane, n-octylamine, 1,6-diamino-hexane, nonanonitrile, 1,7-dicyanoheptane, nonylamine, 1,7-diaminoheptane, decanenitrile, 1,8-dicyanooctane, n-decylamine, 1,8-diaminooctane, 4-[[3-cyanopropyl(dimethyl)silyl]oxy-dimethylsilyl]butanenitrile, octylene glycol, sebacic acid, N-butyl benzenesulfonamide, butanediamide and 2,2,3,3,4,4,4-heptafluorobutylamine.

15. The positive pole material according to claim 1, wherein the positive pole protector is butanedinitrile, n-octylamine or glutaronitrile.

16. The positive pole material according to claim 1, wherein the positive pole material comprises the positive pole protector, a positive pole active material, an adhesive and a conductive agent,
wherein the positive pole protector is from about 0.01 wt % to about 10 wt % of the positive pole active material.

17. The positive pole material according to claim 16, wherein the positive pole protector is from about 0.05 wt % to about 5 wt % of the positive pole active material.

18. A positive pole, comprising a positive pole current collector and the positive pole material according to claim 1.

19. A battery, comprising an electrolyte, a negative pole, and a positive pole according to claim 18.

20. A battery pack, comprising a plurality of batteries; wherein the battery comprises the battery according to claim 19;
whereby the batteries are in series or in parallel.
